(19) United States
(12) Patent Application Publication
(10) Pub. No.: US 2016/0178973 A1
(43) Pub. Date: Jun. 23, 2016

(54) Liquid Crystal Display Panel and Liquid Crystal Display Device

(71) Applicant: SHENZHEN CHINA STAR OPTOELECTRONICS TECHNOLOYGY CO., LTD., Guangdong (CN)

(72) Inventor: Xiangyang XU, Guangdong (CN)

(21) Appl. No.: 14/390,353

(22) PCT Filed: Aug. 22, 2014
(86) PCT No.: PCT/CN2014/084996

§ 371 Date: Oct. 2, 2014

(30) Foreign Application Priority Data
Aug. 18, 2014 (CN) 201410409344.8

(51) Int. Cl. G02F 1/1343; G02F 1/1368; G02F 1/1345; G02F 1/1362

(52) U.S. Cl. CPC G02F 1/134336; G02F 1/136286; G02F 1/1368; G02F 1/13452

(57) ABSTRACT

An LCD and an LCD panel are proposed. The LCD panel includes a first display region and a second region. Both of the first display region and the second display region include the pixels in multiple rows, and the first display region and the second display region are driven by synchronous driving signals. By using the present invention, the technological problem that the charge time is too long to satisfy charge requirement in the conventional technology is solved.

### BACKGROUND OF THE INVENTION

1. Field of the Invention

The present invention relates to the field of liquid crystal displays (LCDs), and more particularly, to an LCD panel and an LCD device.

2. Description of the Prior Art

Liquid crystal molecules mix with foreign ions. The foreign ions are ionized in a direct-current (DC) electric field and a polarization residual electric field is formed. The liquid crystal molecules will shift and become transparent in the polarization residual electric field even though no outside electric field is connected. As a result, the display effect of the LCD panel is affected. To solve the problem, the conventional LCD panel is alternating-current (AC) driven. The AC driving methods comprise frame inversion, row inversion, column inversion, and dot inversion. Dot inversion is widely used owing to its excellent display effect.

In the dot inversion scheme, signals are displayed in opposite polarity so pixel electrodes need double charging energy. Accordingly, a corresponding charge time is needed, resulting in low charging efficiency. To enhance the charging efficiency of the LCD panel, a pre-charging method is usually used. Specifically speaking, the scanning time of a gate is doubled using the pre-charging method. However, the pre-charging method cannot satisfy the demand once larger charging energy is needed.

### SUMMARY OF THE INVENTION

The present invention provides an LCD panel and an LCD device for solving some technological problems occurring in the conventional technology such as a longer charge time and deficient in charge requirement.

According to the present invention, a liquid crystal display (LCD) panel comprises a data line, a scan line, and a plurality of pixels formed by an interlace of the data line and the scan line.

The LCD panel comprises a first display region and a second display region, both of the first display region and the second display region comprise the pixels in a plurality of rows, and the first display region and the second display region are driven by synchronous driving signals.

Upon the condition that the LCD panel comprises the pixels in 2n rows, the pixels in n rows are in both of the first display region and the second display region where n is a positive integer.

Upon the condition that the LCD panel comprises the pixels in 2n+1 rows where n is a positive integer, the first display region comprises the pixels in n+1 rows, and the second display region comprises the pixels in n rows.

In one aspect of the present invention, each pixel comprises a thin-film transistor (TFT).

The LCD panel further comprises a source driving chip and a gate driving chip.

The gate driving chip comprises a first gate driving chip and a second gate driving chip.

The source driving chip comprises a first source driving chip and a second source driving chip.

The first gate driving chip inputs a first scan signal to a control terminal of the TFT of the pixel in the first display region through the scan line.

The second gate driving chip inputs a second scan signal to a control terminal of the TFT of the pixel in the second display region through the scan line.

The first source driving chip inputs a data signal to an input terminal of the TFT of the pixel in the first display region through the data line.

The second source driving chip inputs a data signal to an input terminal of the TFT of the pixel in the second display region through the data line.

The first scan signal and the second scan signal first are generated by the first gate driving chip and the second gate driving chip based on an identical clock signal.

In another aspect of the present invention, the data line in the first display region is independent of the data line in the second display region.

According to the present invention, a liquid crystal display (LCD) panel comprises a data line, a scan line, and a plurality of pixels formed by an interlace of the data line and the scan line.

The LCD panel comprises a first display region and a second display region, both of the first display region and the second display region comprise the pixels in a plurality of rows, and the first display region and the second display region are driven by synchronous driving signals.

In one aspect of the present invention, upon the condition that the LCD panel comprises the pixels in 2n rows, the pixels in n rows are in both of the first display region and the second display region where n is a positive integer.

In another aspect of the present invention, upon the condition that the LCD panel comprises the pixels in 2n+1 rows where n is a positive integer, the first display region comprises the pixels in n+1 rows, and the second display region comprises the pixels in n rows.

In another aspect of the present invention, upon the condition that the LCD panel comprises the pixels in 2n+1 rows where n is a positive integer, the first display region comprises the pixels in n rows, and the second display region comprises the pixels in n+1 rows.

In still another aspect of the present invention, each pixel comprises a thin-film transistor (TFT).

The LCD panel further comprises a source driving chip and a gate driving chip.

The gate driving chip comprises a first gate driving chip and a second gate driving chip.

The source driving chip comprises a first source driving chip and a second source driving chip.

The first gate driving chip inputs a first scan signal to a control terminal of the TFT of the pixel in the first display region through the scan line.

The second gate driving chip inputs a second scan signal to a control terminal of the TFT of the pixel in the second display region through the scan line.

The first source driving chip inputs a data signal to an input terminal of the TFT of the pixel in the first display region through the data line.

The second source driving chip inputs a data signal to an input terminal of the TFT of the pixel in the second display region through the data line.

The first scan signal and the second scan signal first are generated by the first gate driving chip and the second gate driving chip based on an identical clock signal.

In yet another aspect of the present invention, the data line in the first display region is independent of the data line in the second display region.

According to the present invention, a liquid crystal display (LCD) comprises a backlight module and an LCD panel. The LCD panel comprises a data line, a scan line, and a plurality of pixels formed by an interlace of the data line and the scan line.

The LCD panel comprises a first display region and a second display region, both of the first display region and the second display region comprise the pixels in a plurality of rows, and the first display region and the second display region are driven by synchronous driving signals.

In one aspect of the present invention, upon the condition that the LCD panel comprises the pixels in 2n rows, the pixels in n rows are in both of the first display region and the second display region where n is a positive integer.

In another aspect of the present invention, upon the condition that the LCD panel comprises the pixels in 2n+1 rows where n is a positive integer, the first display region comprises the pixels in n+1 rows, and the second display region comprises the pixels in n rows.

In another aspect of the present invention, upon the condition that the LCD panel comprises the pixels in 2n+1 rows where n is a positive integer, the first display region comprises the pixels in n rows, and the second display region comprises the pixels in n+1 rows.

In still another aspect of the present invention, each pixel comprises a thin-film transistor (TFT).

The LCD panel further comprises a source driving chip and a gate driving chip.

The gate driving chip comprises a first gate driving chip and a second gate driving chip.

The source driving chip comprises a first source driving chip and a second source driving chip.

The first gate driving chip inputs a first scan signal to a control terminal of the TFT of the pixel in the first display region through the scan line.

The second gate driving chip inputs a second scan signal to a control terminal of the TFT of the pixel in the second display region through the scan line.

The first source driving chip inputs a data signal to an input terminal of the TFT of the pixel in the first display region through the data line.

The second source driving chip inputs a data signal to an input terminal of the TFT of the pixel in the second display region through the data line.

The first scan signal and the second scan signal first are generated by the first gate driving chip and the second gate driving chip based on an identical clock signal.

In yet another aspect of the present invention, the data line in the first display region is independent of the data line in the second display region.

In the present invention, the LCD panel is divided into two display regions. The display regions are driven synchronously for reducing the charge time. Thus, the technological problem of the conventional technology that the charge time is too long to satisfy charge requirement is solved.

### BRIEF DESCRIPTION OF THE DRAWINGS

FIG. 1 shows a schematic diagram of the structure of an LCD panel comprising pixels arranged in even rows according to a preferred embodiment of the present invention.

FIG. 2 is a schematic diagram showing the structure of a driving circuit in the LCD panel shown in FIG. 1.

FIG. 3 shows a schematic diagram of the structure of an LCD panel comprising the pixels arranged in odd rows according to the preferred embodiment of the present invention.

FIG. 4 is a schematic diagram of the structure of a driving circuit in the LCD panel shown in FIG. 3.

FIG. 5 is a timing diagram showing the related signals applied in the LCD panel according to the embodiment of the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

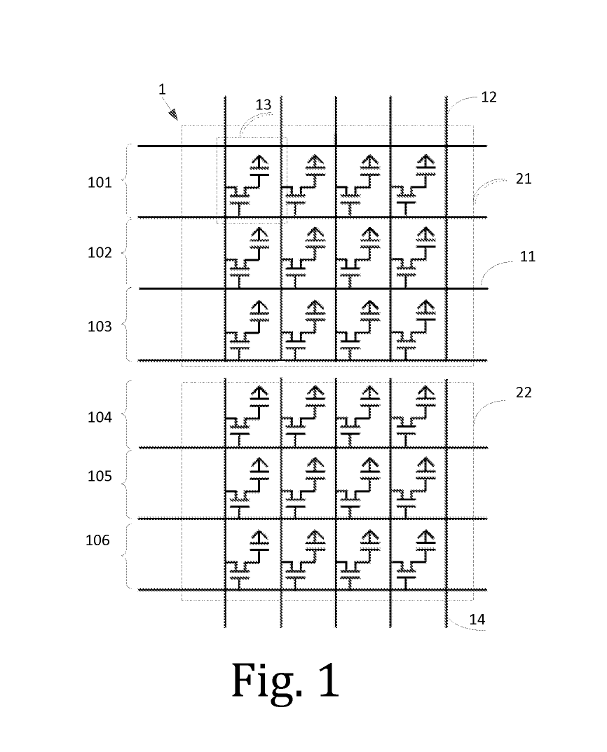

Refer to FIG. 1 showing a schematic diagram of the structure of an LCD panel 1 comprising pixels 13 arranged in even rows according to a preferred embodiment of the present invention.

FIG. 1 shows the LCD panel 1 comprising data lines 12 and 14, a scan line 11, and a plurality of pixels 13. The data lines 12 and 14 interlace the scan line 11 and then the plurality of pixels 13 are formed.

The LCD panel 1 comprises a first display region 21 and a second display region 22. Both of the first display region 21 and the second display region 22 comprise the plurality of pixels in a plurality of rows. The first display region 21 and the second display region 22 are driven by a synchronous driving signal.

Preferably, the LCD panel 1 comprises the plurality of pixels 13 in 2n rows, and n is a positive integer. The first display region 21 and the second display region 22 both comprise the pixels 13 in n rows. FIG. 1 shows that the LCD panel 1 comprises the pixels 13 in six rows. The first display region 21 comprises the pixels 13 in upper three rows (101-103). The second display region 22 comprises the pixels 13 in lower three rows (104-106).

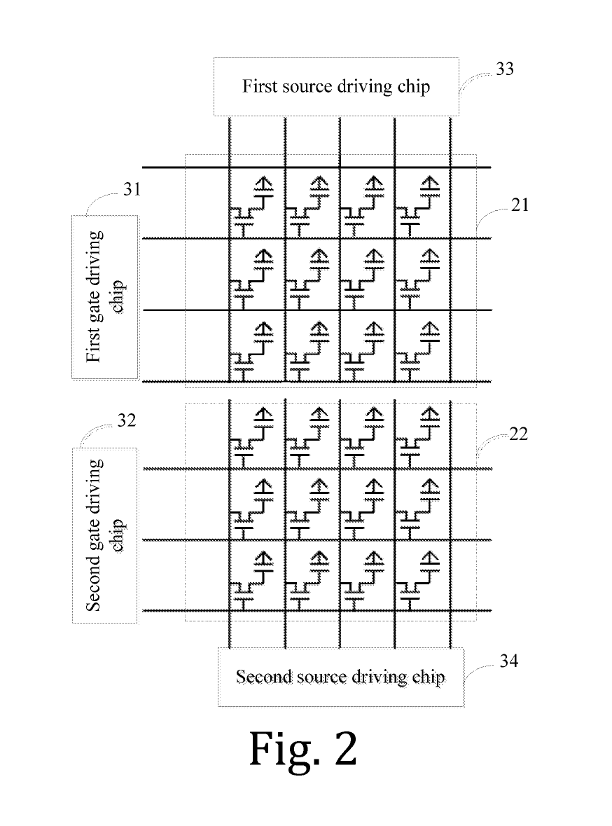

The driving method of the LCD panel 1 is explained in detail as FIG. 2 shows. FIG. 2 is a schematic diagram showing the structure of a driving circuit in the LCD panel 1 shown in FIG. 1. The pixel 13 comprises a thin-film transistor (TFT). The LCD panel 1 also comprises a source driving chip and a gate driving chip.

The gate driving chip comprises a first gate driving chip 31 and a second gate driving chip 32. The source driving chip comprises a first source driving chip 33 and a second source driving chip 34.

Please refer to FIG. 1 as well. The data lines in the first display region 21 are independent of the data lines in the second display region 22. The first gate driving chip 31 inputs a first scan signal to a control terminal of the TFT of the pixel 13 in the first display region 21 through the scan line 11. The first source driving chip 33 inputs a data signal to an input terminal of the TFT of the pixel 13 in the first display region 21 through the data line 12.

The second gate driving chip 32 inputs a second scan signal to a control terminal of the TFT of the pixel 13 in the second display region 22 through the scan line 11. The second source driving chip 34 inputs a data signal to an input terminal of the TFT of the pixel 13 in the second display region 22 through the data line 14.

The first scan signal and the second scan signal first are generated by the first gate driving chip 31 and the second gate driving chip 32 based on an identical clock signal.

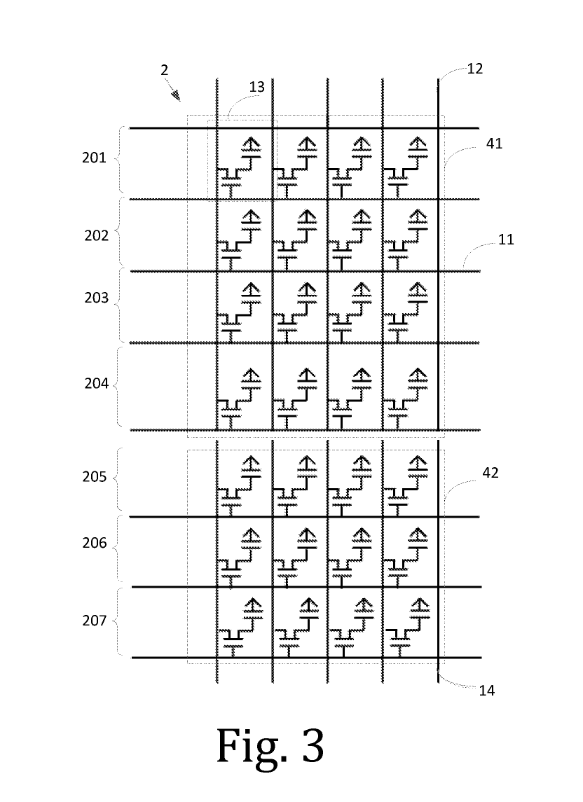

Refer to FIG. 3 showing a schematic diagram of the structure of an LCD panel 2 comprising the pixels 13 arranged in odd rows according to the preferred embodiment of the present invention. When the LCD panel 2 comprises the pixels 13 in 2n+1 rows where n is a positive integer, the first display region comprises the pixels 13 in n+1 rows, and the second display region comprises the pixels 13 in n rows. Or, when the LCD panel 2 comprises the pixels 13 in 2n+1 rows, the first display region comprises the pixels 13 in n rows, and the second display region comprises the pixels 13 in n+1 rows. For example, when the LCD panel 2 comprises the pixels 13 in 7 rows, the pixels in the 201-204 rows in the LCD panel 2 belong to a first display region 41, and the pixels in the 205-207 rows in the LCD panel 2 belong to a second display region 42. Or, when the LCD panel 2 comprises the pixels 13 in 7 rows, the pixels in the 201-203 rows in the LCD panel 2 belong to the first display region 41, and the pixels in the 204-207 rows in the LCD panel 2 belong to the second display region 42.

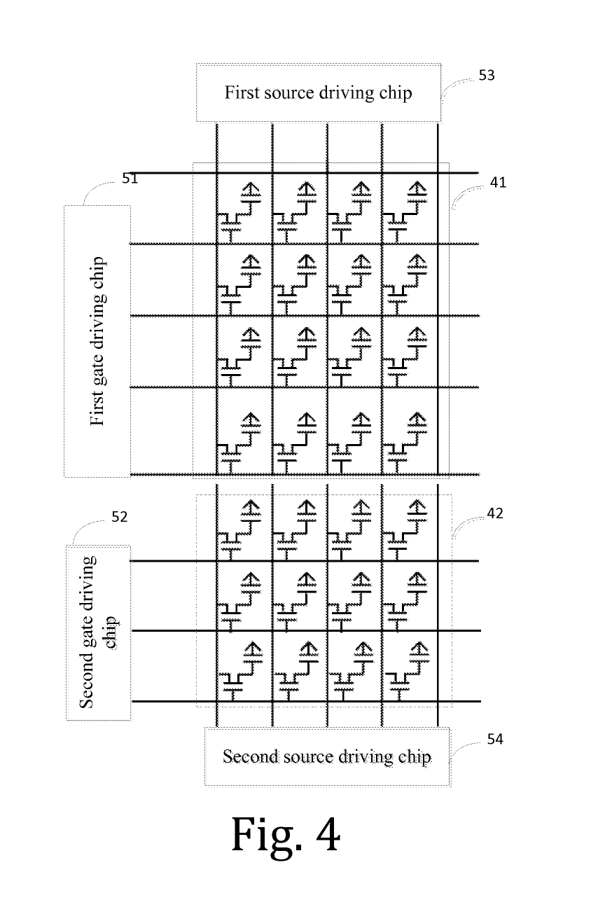

The driving method of the LCD panel 2 is explained in detail as FIG. 4 shows. FIG. 4 is a schematic diagram of the structure of a driving circuit in the LCD panel 2 shown in FIG. 3.

Please refer to FIG. 3 as well. The pixel 13 comprises a TFT. The LCD panel 2 also comprises a source driving chip and a gate driving chip.

The gate driving chip comprises a first gate driving chip 51 and a second gate driving chip 52. The source driving chip comprises a first source driving chip 53 and a second source driving chip 54.

The data lines in the first display region 41 are independent of the data lines in the second display region 42. The first gate driving chip 51 inputs a first scan signal to a control terminal of the TFT of the pixel 13 in the first display region 41 through the scan line 11. The first source driving chip 53 inputs a data signal to an input terminal of the TFT of the pixel 13 in the first display region 41 through the data line 12.

The second gate driving chip 52 inputs a second scan signal to a control terminal of the TFT of the pixel 13 in the second display region 42 through the scan line 11. The second source driving chip 54 inputs a data signal to an input terminal of the TFT of the pixel 13 in the second display region 42 through the data line 14.

The first scan signal and the second scan signal first are generated by the first gate driving chip 51 and the second gate driving chip 52 based on an identical clock signal.

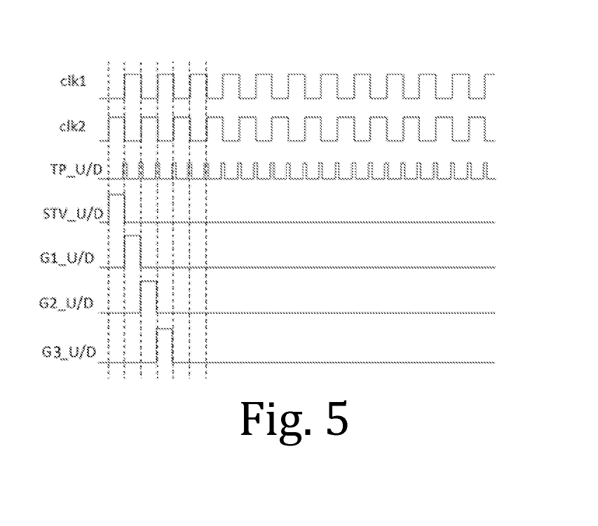

FIG. 5 is a timing diagram showing the related signals applied in the LCD panel according to the embodiment of the present invention. FIG. 5 merely shows one frame of the signal. Each of the display regions is driven by a synchronous driving signal. The driving signal is generated based on an identical clock signal. The scan signal of the gate driving chip is generated based on the clock signal, which means that the gate driving chip in each of the display regions generates the same control signal. The refresh frequency of the frame is ƒ. The time spent on scanning the pixel in each of the rows is 1/(f*m) where m represents the number of rows of the pixels. The display regions are driven through the synchronous driving signal so the frequency for each of the display regions maintains the same. When the LCD panel comprises the pixels in 2n rows where n is a positive integer and the display regions comprise the pixels in the same rows, the pixels comprise n rows. It means that the rows of pixels in each of the display regions are half the rows of pixels in the LCD panel. Therefore, the time spent on scanning the rows of each of the display regions doubles, which increases charging efficiency.

The LCD panel comprises the plurality of pixels 13 in 2n+1 rows, and n is a positive integer. One of the display regions comprises pixels in n rows. The other display region comprises pixels in n+1 rows. The rows of pixels in each of the display regions are around half the rows of pixels in the LCD panel. Therefore, the time spent on scanning the rows of each of the display regions doubles roughly, which increases charging efficiency.

The driving signal may be a clock signal. Preferably, the clock signal as the driving signal comprises two sub-clock signals. The period of the sub-clock signals is identical while the polarities of the sub-clock signals are opposite. Take the LCD panel comprising two display regions comprising the same number of rows of pixels for example. A scan signal is generated by the gate driving chip in the first display region and the second display region based on the two sub-clock signals. Take the LCD panel comprising the pixels with six rows for example, as shown in FIG. 5. The period of a first sub-clock signal clk1 and the period of a second sub-clock signal clk2 are the same while the polarities of the two sub-clock signals are opposite. TP_U/D represents an output control signal of a data signal generated by the first display region and the second display region. When the output control signal TP_U/D is at low level, the data signal is output. STV_U/D represents a trigger signal of a gate driving signal generated by the first display region and the second display region. Please refer to FIG. 1 as well. G1_U/D represents the scan signal of the pixels in the first row 101 in the first display region 21 or the scan signal of the pixels in the first row 104 in the second display region 22. G2_U/D represents the scan signal of the pixels in the second row 102 in the first display region 21 or the scan signal of the pixels in the second row 105 in the second display region 22. G3_U/D represents the scan signal of the pixels in the third row 103 in the first display region 21 or the scan signal of the pixels in the third row 106 in the second display region 22. The first sub-clock signal clk1 corresponds to the first row 101 or the first row 104. The second sub-clock signal clk2 corresponds to the second row 102 or the second row 105. The first sub-clock signal clk1 corresponds to the third row 103 or the second row 106. When the sub-clock signals clk1 and clk2 are at high level, the scan signal of the pixels in a corresponding row is at high level.

Compared with a method for driving the clock signal, the scanning period is shortened to be half through the two sub-clock signals because the scanning period of the scan signal of a following pixel (such as G2_U/D) is half the scanning period of the scan signal of a previous pixel (such as G1_U/D). Therefore, the efficiency of charging the pixels in rows is increased. Besides, the response speed of displaying the pixels and the display quality are increased as well.

The LCD panel is divided into two display regions in the present invention. The display regions are driven synchronously for reducing the charge time. Thus, the technological problem that the charge time is too long to satisfy charge requirement in the conventional technology is solved.

The present invention further proposes a liquid crystal display (LCD) comprising a backlight module and an LCD panel. The LCD panel comprises a data line, a scan line, and a plurality of pixels formed by an interlace of the data line and the scan line.

The LCD panel comprises a first display region and a second display region, both of the first display region and the second display region comprise the pixels in a plurality of rows, and the first display region and the second display region are driven by synchronous driving signals.

Upon the condition that the LCD panel comprises the pixels in 2n rows, the pixels in n rows are in both of the first display region and the second display region where n is a positive integer.

Upon the condition that the LCD panel comprises the pixels in 2n+1 rows where n is a positive integer, the first display region comprises the pixels in n+1 rows, and the second display region comprises the pixels in n rows.

Upon the condition that the LCD panel comprises the pixels in 2n+1 rows where n is a positive integer, the first display region comprises the pixels in n rows, and the second display region comprises the pixels in n+1 rows.

The LCD panel as mentioned above is driven based on the following way. Each pixel comprises a thin-film transistor (TFT). The LCD panel further comprises a source driving chip and a gate driving chip.

The gate driving chip comprises a first gate driving chip and a second gate driving chip.

The source driving chip comprises a first source driving chip and a second source driving chip.

The data line in the first display region is independent of the data line in the second display region. The first gate driving chip inputs a first scan signal to a control terminal of the TFT of the pixel in the first display region through the scan line. The second gate driving chip inputs a second scan signal to a control terminal of the TFT of the pixel in the second display region through the scan line. The first scan signal and the second scan signal first are generated by the first gate driving chip and the second gate driving chip based on an identical clock signal.

The first source driving chip inputs a data signal to an input terminal of the TFT of the pixel in the first display region through the data line. The second source driving chip inputs a data signal to an input terminal of the TFT of the pixel in the second display region through the data line.

Each of the LCD panels described above can be used in the LCD device in the present invention. Since the LCD panels are detailed above, no details of the LCD device is provided hereafter.

The LCD panel used in the LCD is divided into two display regions in the present invention. The display regions are driven synchronously for reducing the charge time. Thus, the technological problem that the charge time is too long to satisfy charge requirement in the conventional technology is solved.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A liquid crystal display (LCD) panel comprising a data line, a scan line, and a plurality of pixels formed by an interlace of the data line and the scan line;
wherein the LCD panel comprises a first display region and a second display region, both of the first display region and the second display region comprise the pixels in a plurality of rows, and the first display region and the second display region are driven by synchronous driving signals;
upon the condition that the LCD panel comprises the pixels in 2n rows, the pixels in n rows are in both of the first display region and the second display region where n is a positive integer;
upon the condition that the LCD panel comprises the pixels in 2n+1 rows where n is a positive integer, the first display region comprises the pixels in n+1 rows, and the second display region comprises the pixels in n rows.

2. The LCD panel as claimed in claim 1, wherein each pixel comprises a thin-film transistor (TFT);
the LCD panel further comprises a source driving chip and a gate driving chip;
the gate driving chip comprises a first gate driving chip and a second gate driving chip;
the source driving chip comprises a first source driving chip and a second source driving chip;
the first gate driving chip inputs a first scan signal to a control terminal of the TFT of the pixel in the first display region through the scan line;
the second gate driving chip inputs a second scan signal to a control terminal of the TFT of the pixel in the second display region through the scan line;
the first source driving chip inputs a data signal to an input terminal of the TFT of the pixel in the first display region through the data line;
the second source driving chip inputs a data signal to an input terminal of the TFT of the pixel in the second display region through the data line;
the first scan signal and the second scan signal first are generated by the first gate driving chip and the second gate driving chip based on an identical clock signal.

3. The LCD panel as claimed in claim 1, wherein the data line in the first display region is independent of the data line in the second display region.

4. A liquid crystal display (LCD) panel comprising a data line, a scan line, and a plurality of pixels formed by an interlace of the data line and the scan line;
wherein the LCD panel comprises a first display region and a second display region, both of the first display region and the second display region comprise the pixels in a plurality of rows, and the first display region and the second display region are driven by synchronous driving signals.

5. The LCD panel as claimed in claim 4, wherein upon the condition that the LCD panel comprises the pixels in 2n rows, the pixels in n rows are in both of the first display region and the second display region where n is a positive integer.

6. The LCD panel as claimed in claim 4, wherein upon the condition that the LCD panel comprises the pixels in 2n+1 rows where n is a positive integer, the first display region comprises the pixels in n+1 rows, and the second display region comprises the pixels in n rows.

7. The LCD panel as claimed in claim 4, wherein upon the condition that the LCD panel comprises the pixels in 2n+1 rows where n is a positive integer, the first display region comprises the pixels in n rows, and the second display region comprises the pixels in n+1 rows.

8. The LCD panel as claimed in claim 4, wherein each pixel comprises a thin-film transistor (TFT);
the LCD panel further comprises a source driving chip and a gate driving chip;
the gate driving chip comprises a first gate driving chip and a second gate driving chip;
the source driving chip comprises a first source driving chip and a second source driving chip;
the first gate driving chip inputs a first scan signal to a control terminal of the TFT of the pixel in the first display region through the scan line;
the second gate driving chip inputs a second scan signal to a control terminal of the TFT of the pixel in the second display region through the scan line;
the first source driving chip inputs a data signal to an input terminal of the TFT of the pixel in the first display region through the data line;
the second source driving chip inputs a data signal to an input terminal of the TFT of the pixel in the second display region through the data line;
the first scan signal and the second scan signal first are generated by the first gate driving chip and the second gate driving chip based on an identical clock signal.

9. The LCD panel as claimed in claim 4, wherein the data line in the first display region is independent of the data line in the second display region.

10. A liquid crystal display (LCD) comprising:
a backlight module; and
an LCD panel comprising a data line, a scan line, and a plurality of pixels formed by an interlace of the data line and the scan line;
wherein the LCD panel comprises a first display region and a second display region, both of the first display region and the second display region comprise the pixels in a plurality of rows, and the first display region and the second display region are driven by synchronous driving signals.

11. The LCD as claimed in claim 10, wherein upon the condition that the LCD panel comprises the pixels in 2n rows, the pixels in n rows are in both of the first display region and the second display region where n is a positive integer.

12. The LCD as claimed in claim 10, wherein upon the condition that the LCD panel comprises the pixels in 2n+1 rows where n is a positive integer, the first display region comprises the pixels in n+1 rows, and the second display region comprises the pixels in n rows.

13. The LCD as claimed in claim 10, wherein upon the condition that the LCD panel comprises the pixels in 2n+1 rows where n is a positive integer, the first display region comprises the pixels in n rows, and the second display region comprises the pixels in n+1 rows.

14. The LCD as claimed in claim 10, wherein each pixel comprises a thin-film transistor (TFT);
the LCD panel further comprises a source driving chip and a gate driving chip;
the gate driving chip comprises a first gate driving chip and a second gate driving chip;
the source driving chip comprises a first source driving chip and a second source driving chip;
the first gate driving chip inputs a first scan signal to a control terminal of the TFT of the pixel in the first display region through the scan line;
the second gate driving chip inputs a second scan signal to a control terminal of the TFT of the pixel in the second display region through the scan line;
the first source driving chip inputs a data signal to an input terminal of the TFT of the pixel in the first display region through the data line;
the second source driving chip inputs a data signal to an input terminal of the TFT of the pixel in the second display region through the data line;
the first scan signal and the second scan signal first are generated by the first gate driving chip and the second gate driving chip based on an identical clock signal.

15. The LCD as claimed in claim 10, wherein the data line in the first display region is independent of the data line in the second display region.
